(19) United States
(12) Patent Application Publication
(10) Pub. No.: US 2026/0003968 A1
(43) Pub. Date: Jan. 1, 2026

(54) VEHICLE

(71) Applicant: SUBARU CORPORATION, Tokyo (JP)

(72) Inventors: Kazuki FUJITA, Tokyo (JP); Satoru SUZUKI, Tokyo (JP)

(21) Appl. No.: 19/230,276

(22) Filed: Jun. 6, 2025

(30) Foreign Application Priority Data
Jun. 26, 2024 (JP) 2024-103225

(51) Int. Cl. G06F 21/57; B60R 25/04

(52) U.S. Cl. CPC G06F 21/575; B60R 25/04

(57) ABSTRACT

A vehicle includes a control electronic control unit and a monitoring electronic control unit. The control electronic control unit is configured to control an object device mounted on the vehicle, and the monitoring electronic control unit is configured to monitor the control electronic control unit. The control electronic control unit is configured to store a startup program and a first verification program for verifying whether the startup program has been tampered with in a writable first storage medium, calculate a hash value for the first verification program, and output the calculated hash value to the monitoring electronic control unit. The monitoring electronic control unit is configured to determine an abnormality in the control electronic control unit based on the hash value received from the control electronic control unit.

### CROSS-REFERENCE TO RELATED APPLICATIONS

The present application claims priority from Japanese Patent Application No. 2024-103225 filed on June 26, 2024, the entire contents of which are hereby incorporated by reference.

### BACKGROUND

The disclosure relates to the technical field of vehicles. A vehicle has been proposed which includes a first monitoring unit configured to monitor monitored units and a second monitoring unit configured to monitor the first monitoring unit. In the vehicle, the first monitoring unit monitors the monitored units by comparing hash values, and the second monitoring unit monitors the first monitoring unit by comparing hash values (see, e.g., Japanese Patent No. 7325072).

### SUMMARY

A vehicle according to an embodiment of the disclosure includes a control electronic control unit (ECU) and a monitoring ECU. The control ECU is configured to control an object device mounted on the vehicle, and the monitoring ECU is configured to monitor the control ECU. The control ECU is configured to store a startup program and a first verification program for verifying whether the startup program has been tampered with in a writable first storage medium, calculate a first hash value for the first verification program, and output the calculated first hash value to the monitoring ECU. The monitoring ECU is configured to determine an abnormality in the control ECU based on the first hash value received from the control ECU.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a block diagram illustrating an exemplary configuration of a vehicle;

FIG. 2 is a block diagram illustrating a configuration of a monitoring ECU;

FIG. 3 is a block diagram illustrating a configuration of a control ECU;

FIG. 4 is a diagram illustrating data stored in a ROM and a non-volatile memory;

FIG. 5 is a diagram illustrating data stored in a ROM and a non-volatile memory;

FIG. 6 is a flowchart illustrating a process performed at startup of the control ECU; and

FIG. 7 is a flowchart illustrating a process performed at startup of the monitoring ECU.

### DETAILED DESCRIPTION

At startup of an electronic control unit (ECU) mounted on a vehicle, a boot image is securely booted, for example, by a Root of Trust (hereinafter referred to as RoT). If the RoT is tampered with, it will not be possible to verify whether the boot image has been tampered with. Therefore, the RoT is stored in a secure storage medium.

However, when the vehicle is to be used for a long period time, there will be occasions where the RoT itself is to be updated. When the RoT is stored in a secure storage medium, it would be necessary to replace the ECU itself.

It is desirable to enable long-term use of the ECU. In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

### 1. Configuration of Vehicle

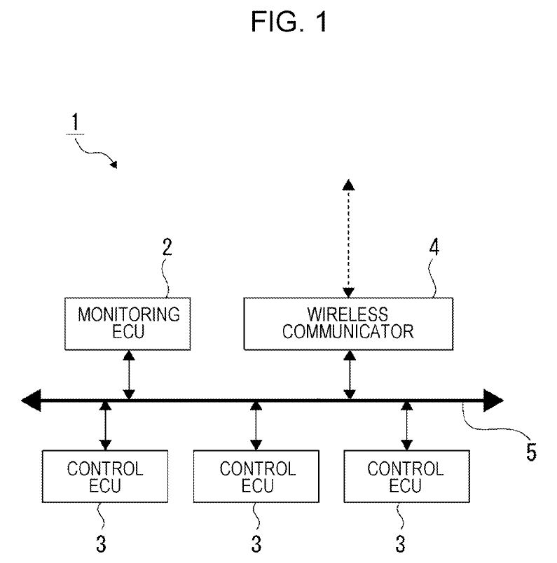

FIG. 1 is a block diagram illustrating an exemplary configuration of a vehicle 1 according to the embodiment. As illustrated in FIG. 1, the vehicle 1 includes a monitoring ECU 2, a control ECU 3, and a wireless communicator 4.

The monitoring ECU 2 is a cybersecurity control ECU that monitors the control ECU 3.

The control ECU 3 controls an object device mounted on the vehicle 1 and is provided for each object device. This means that the vehicle 1 includes many control ECUs 3. However, the vehicle 1 may include one control ECU 3.

Examples of the control ECU 3 include an engine ECU that controls an engine, a motor ECU that controls a motor generator, a car navigation system ECU that controls a car navigation system, and a power ECU that controls READY-ON and READY-OFF of the vehicle 1 on the basis of a user's operation. The wireless communicator 4 that wirelessly communicates with a data server via a network is also an example of the control ECU 3.

The wireless communicator 4 wirelessly communicates with an external device (server) via a network. The wireless communicator 4 is capable of acquiring, for example, data for updating a program from a server outside the vehicle by an over-the-air (OTA) method.

The monitoring ECU 2, the control ECU 3, and the wireless communicator 4 are coupled via a bus 5, and this enables transmission and reception of data between them.

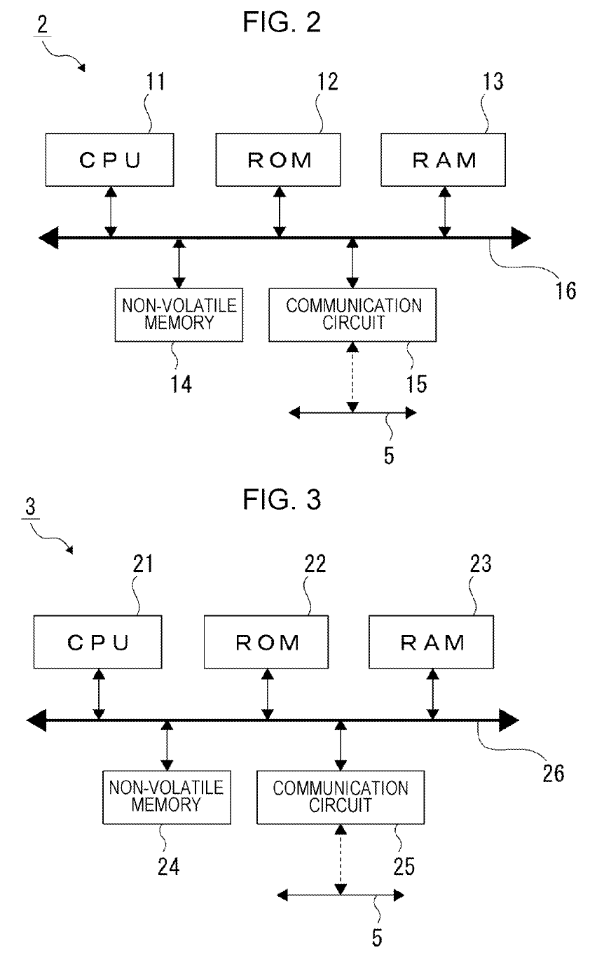

FIG. 2 is a block diagram illustrating a configuration of the monitoring ECU 2. As illustrated in FIG. 2, the monitoring ECU 2 includes a central processing unit (CPU) 11, a read-only memory (ROM) 12, a random-access memory (RAM) 13, a non-volatile memory 14, and a communication circuit 15.

The CPU 11 expands, in the RAM 13, a program stored in the ROM 12 or the non-volatile memory 14 and executes the program to operate in accordance with the program.

The ROM 12 allows stored data to be read therefrom, but does not allow data to be written thereto.

The RAM 13 stores, for example, temporary data necessary for the CPU 11 to perform a predetermined process.

The non-volatile memory 14 allows stored data to be read therefrom, and also allows data to be written thereto.

The communication circuit 15 communicates with other on-vehicle devices mounted on the vehicle 1 via the bus 5.

The CPU 11, the ROM 12, the RAM 13, the non-volatile memory 14, and the communication circuit 15 are coupled via a bus 16, and this enables transmission and reception of data between them.

FIG. 3 is a block diagram illustrating a configuration of the control ECU 3. As illustrated in FIG. 3, the control ECU 3 includes, like the monitoring ECU 2, a CPU 21, a ROM 22, a RAM 23, a non-volatile memory 24, and a communication circuit 25.

The CPU 21 expands, in the RAM 23, a program stored in the ROM 22 or the non-volatile memory 24 and executes the program to operate in accordance with the program.

The ROM 22 allows stored data to be read therefrom, but does not allow data to be written thereto.

The RAM 23 stores, for example, temporary data necessary for the CPU 21 to perform a predetermined process.

The non-volatile memory 24 allows stored data to be read therefrom, and also allows data to be written thereto.

The communication circuit 25 communicates with other on-vehicle devices mounted on the vehicle 1 via the bus 5.

The CPU 21, the ROM 22, the RAM 23, the non-volatile memory 24, and the communication circuit 25 are coupled via a bus 26, and this enables transmission and reception of data between them.

Examples of the control ECU 3 also include one that performs control related to driving of the vehicle 1. If the startup program of the control ECU 3 is tampered with, the driving of the vehicle 1 may be affected. Therefore, the ECUs (monitoring ECU 2, control ECU 3) include a program (hereinafter referred to as Root of Trust (RoT)) for verifying whether the startup program has been tampered with.

The RoT has an integrity verification function (secure boot function) that verifies the integrity of the startup program executed at startup of the ECU, such as an operating system (OS) or an application program. A startup program loaded at startup of the ECU, such as an OS or an application program, is referred to as a boot image.

The RoT verifies that the boot image is not tampered with, or verifies, when the boot image is updated, that update information is not tampered with or is provided by a trusted developer.

This means that if the RoT itself is tampered with, it will not be possible to verify whether the boot image has been tampered with. In normal vehicles, therefore, the RoT is stored in a secure storage area that is not writable. However, for example, when a public key used to verify tampering is updated by a certificate authority, the public key cannot be updated if the RoT is stored in a secure storage area. In such a case, for example, it would be necessary to take the vehicle 1 to a car dealership and change the ECU itself.

Accordingly, in the vehicle 1, the RoT is stored in the non-volatile memory 24 to enable updating, and the RoT stored in the non-volatile memory 24 is monitored by the monitoring ECU 2 to ensure security.

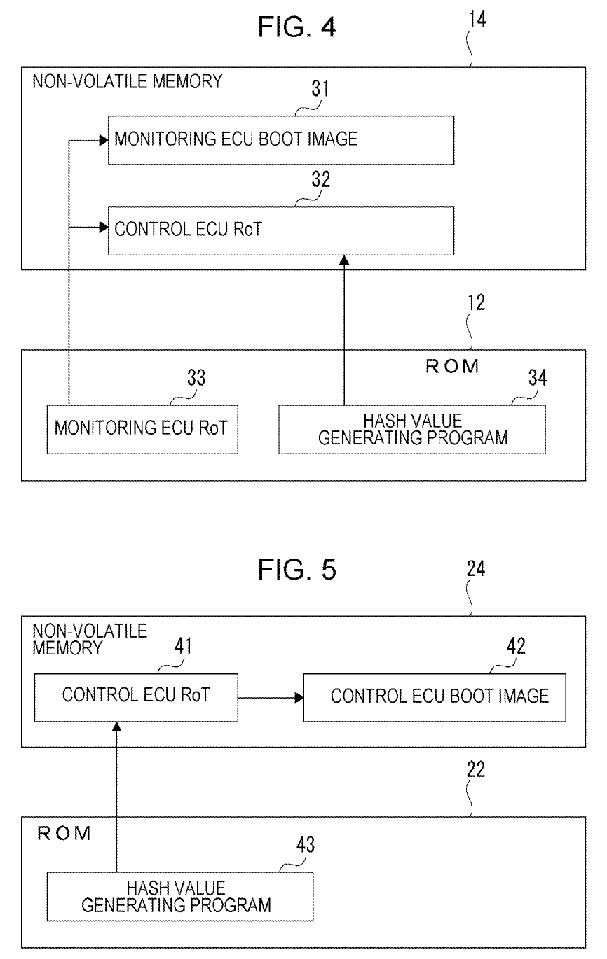

FIG. 4 is a diagram illustrating data stored in the ROM 12 and the non-volatile memory 14. FIG. 5 is a diagram illustrating data stored in the ROM 22 and the non-volatile memory 24.

As illustrated in FIG. 4, the non-volatile memory 14 of the monitoring ECU 2 stores a boot image (hereinafter referred to as monitoring ECU boot image) 31 that the monitoring ECU 2 (CPU 11) executes at startup, and an RoT (hereinafter referred to as control ECU RoT) 32 for verifying whether the boot image has been tampered with in the control ECU 3.

The ROM 12 of the monitoring ECU 2 stores an RoT (hereinafter referred to as monitoring ECU RoT) 33 for verifying whether the monitoring ECU boot image 31 has been tampered with, and for verifying whether the control ECU RoT 32 has been tampered with. The ROM 12 further stores a hash value generating program 34 for generating hash values.

As illustrated in FIG. 5, the non-volatile memory 24 of the control ECU 3 stores a control ECU RoT 41 for verifying whether a control ECU boot image 42 has been tampered with, and a boot image (control ECU boot image) 42 that the control ECU 3 (CPU 21) executes at startup.

The ROM 22 of the control ECU 3 stores a hash value generating program 43 for generating hash values.

The control ECU RoT 32 stored in the monitoring ECU 2 is a duplicate of the control ECU RoT 41 stored in the control ECU 3. Therefore, if data has not been tampered with, the control ECU RoT 32 and the control ECU RoT 41 are identical.

The hash value generating program 34 and the hash value generating program 43 are the same program, and can generate the same hash value from the same data.

Thus, in the monitoring ECU 2, the monitoring ECU RoT 33 and the hash value generating program 34 are stored in the ROM 12 (storage medium), which is not writable, and these data cannot be tampered with. In the control ECU 3, the hash value generating program 43 is stored in the ROM 22 (storage medium), which is not writable, and the hash value generating program 43 cannot be tampered with.

In the monitoring ECU 2, the monitoring ECU boot image 31 and the control ECU RoT 32 are stored in the non-volatile memory 14, which is writable, and these data can be updated. In the control ECU 3, the control ECU RoT 41 and the control ECU boot image 42 are stored in the non-volatile memory 24, which is writable, and these data can be updated.

Thus, in the control ECU 3, an object to be controlled can be controlled on the basis of a program updated by updating the control ECU boot image 42. In the control ECU 3, for example, when a public key is updated, the control ECU RoT 41 can be updated without replacing the control ECU 3, and long-term use of the control ECU 3 is possible.

When the control ECU RoT 41 is stored in the non-volatile memory 24, which is writable, the control ECU RoT 41 may be tampered with. If the control ECU RoT 41 is tampered with, it will not be possible to verify whether the control ECU boot image 42 has been tampered with, and this may affect the driving of the vehicle 1.

Accordingly, in the vehicle 1, the monitoring ECU 2 verifies whether the control ECU RoT 41 stored in the non-volatile memory 24 of the control ECU 3 has been tampered with, so that security is ensured. A process will now be described.

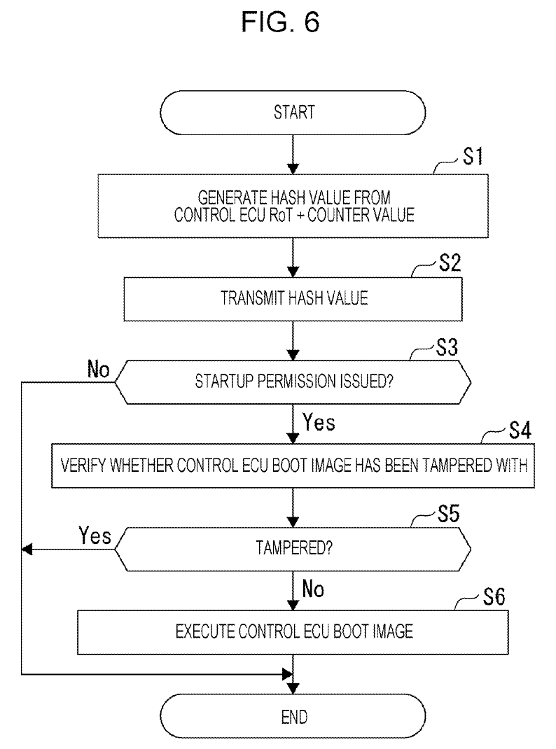

FIG. 6 is a flowchart illustrating a process performed at startup of the control ECU 3. As illustrated in FIG. 6, at startup (READY-ON) of the vehicle 1, in step S1, the CPU 21 loads the hash value generating program 43 into the RAM 23 and executes the hash value generating program 43 to generate a hash value based on the control ECU RoT 41.

For example, on the basis of the hash value generating program 43, the CPU 21 adds a counter value, which is incremented by one at each startup of the vehicle 1, to a data sequence of the control ECU RoT 41 stored in the non-volatile memory 24. The CPU 21 then generates a hash value for a data sequence obtained by adding the counter value to the data sequence of the control ECU RoT 41.

This means that the CPU 21 generates a different hash value at each startup of the vehicle 1, and security of the hash value is improved.

In step S2, the CPU 21 outputs (transmits) the generated hash value to the monitoring ECU 2.

In step S3, the CPU 21 determines whether a startup permission has been issued by the monitoring ECU 2. If a startup permission has been issued by the monitoring ECU 2 (Yes in step S3), the CPU 21 loads the control ECU RoT 41 from the non-volatile memory 24 into the RAM 23 and executes the control ECU RoT 41 to verify whether the control ECU boot image 42 has been tampered with in step S4. Then in step S5, the CPU 21 determines, on the basis of the result of the verification, whether the control ECU boot image 42 has been tampered with.

If the control ECU boot image 42 has not been tampered with (No in step S5), the CPU 21 loads the control ECU boot image 42 into the RAM 23 and executes the control ECU boot image 42 to start controlling an object device in step S6.

If no startup permission has been issued by the monitoring ECU 2 (No in step S3) or if the control ECU boot image 42 has been tampered with (Yes in step S5), the CPU 21 terminates the process without executing the control ECU boot image 42.

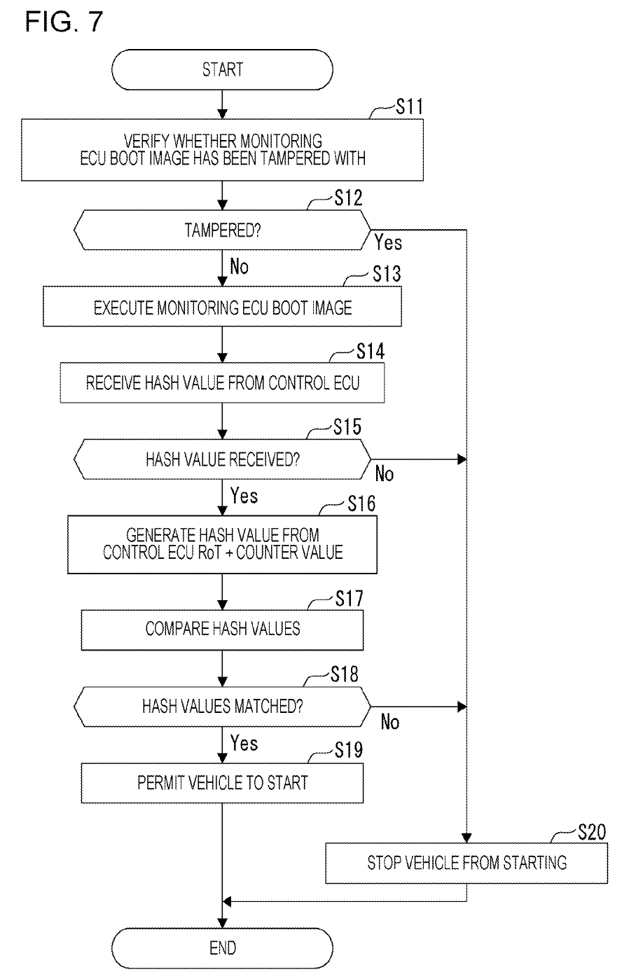

FIG. 7 is a flowchart illustrating a process performed at startup of the monitoring ECU 2. As illustrated in FIG. 7, at the startup (READY-ON) of the vehicle 1, in step S11, the CPU 11 loads the monitoring ECU RoT 33 into the RAM 13 and executes the monitoring ECU RoT 33 to verify whether the monitoring ECU boot image 31 has been tampered with. In step S12, the CPU 11 determines whether the monitoring ECU boot image 31 has been tampered with. If the monitoring ECU boot image 31 has not been tampered with (No in step S12), the CPU 11 expands, in the RAM 13, the monitoring ECU boot image 31 stored in the non-volatile memory 14 and executes the monitoring ECU boot image 31 in step S13 to start monitoring the control ECU 3.

In step S14, the CPU 11 receives the hash value transmitted by the control ECU 3 in step S2. In step S15, the CPU 11 determines whether the hash value has been received in step S14.

If the hash value has been received (Yes in step S15), the CPU 11 loads the hash value generating program 34 into the RAM 13 and executes the hash value generating program 34 to generate a hash value based on the control ECU RoT 32 stored in the non-volatile memory 14 in step S16.

For example, on the basis of the hash value generating program 34, the CPU 11 adds a counter value, which is incremented by one at each startup of the vehicle 1, to a data sequence of the control ECU RoT 32 stored in the non-volatile memory 14. The CPU 11 then generates a hash value for a data sequence obtained by adding the counter value to the data sequence of the control ECU RoT 32.

In step S17, the CPU 11 compares the hash value received in step S14 with the hash value generated in step S16.

If the control ECU RoT 41 has not been tampered with, the hash value received in step S14 is the same value as the hash value generated in step S16. Thus, in step S18, the CPU 11 determines whether the hash values compared in step S17 match.

If the hash values match (Yes in step S18), that is, if the control ECU RoT 41 has not been tampered with, the CPU 11 permits the vehicle 1 to start in step S19. This means that the control ECU 3 determines that a startup permission has been issued in step S3.

If the monitoring ECU boot image 31 has been tampered with (Yes in step S12), no hash value has been received from the control ECU 3 (No in step S15), or the hash values do not match (No in step S18), then the CPU 11 stops the vehicle 1 from starting in step S20.

Thus, in step S14 to step S18, the CPU 11 determines an abnormality in the control ECU 3 on the basis of the hash value received from the control ECU 3. This makes it possible to always verify whether the control ECU RoT 41, which is updatable, has been tampered with.

### 2. Modifications

Although embodiments of the disclosure have been described, the disclosure is not limited to the specific examples described above and can be configured in various ways.

For example, in the embodiments described above, the control ECU RoT 32 is stored in the non-volatile memory 14 of the monitoring ECU 2. However, the CPU 11 may store, in the non-volatile memory 14, a hash value calculated by the control ECU 3 during update of the control ECU RoT 41 after being verified by the monitoring ECU RoT 33. In this case, the CPU 11 may determine whether the hash value received from the control ECU 3 at startup of the vehicle 1 matches the hash value stored in the non-volatile memory 14.

In the embodiments described above, if no hash value has been received from the control ECU 3 (No in step S15), or if the hash values do not match (No in step S18), the vehicle 1 is stopped from starting. However, simply the control ECU 3 may be stopped if no hash value has been received from the control ECU 3, or if the hash values do not match.

In the embodiments described above, the RoT is used as a program for verifying whether the startup program has been tampered with. However, any program other than the RoT may be used, as long as it is capable of verifying whether the startup program has been tampered with.

### 3. Summary of Embodiments

As described above, the vehicle 1 according to the embodiments includes the control ECU 3 configured to control an object device mounted on the vehicle 1, and the monitoring ECU 2 configured to monitor the control ECU 3.

The control ECU 3 is configured to store a startup program (control ECU boot image 42) and a first verification program (control ECU RoT 41) for verifying whether the startup program has been tampered with in a writable first storage medium (non-volatile memory 24), calculate a hash value for the first verification program, and output the calculated hash value to the monitoring ECU 2.

The monitoring ECU 2 is configured to determine an abnormality in the control ECU 3 based on the hash value received from the control ECU 3.

Since the control ECU RoT 41 is stored in the writable non-volatile memory 24, it is possible to update the control ECU RoT 41. The monitoring ECU 2 verifies whether the control ECU RoT 41 stored in the writable non-volatile memory 24 has been tampered with, based on the hash value.

This makes it possible to always verify whether the updatable control ECU RoT 41 has been tampered with. Thus, it is not necessary to take the vehicle 1 to a dealership or the like for updating the control ECU RoT 41, and also not necessary to replace the control ECU 3. The vehicle 1 can thus use the control ECU 3 for a long period of time.

The control ECU 3 is configured to store the hash value generating program 43 for generating hash values for the first verification program in a read-only second storage medium (ROM 22), and generate a hash value for the first verification program based on the hash value generating program 43.

The monitoring ECU 2 is configured to store the first verification program (control ECU RoT 32) in a writable third storage medium (non-volatile memory 14), generate a hash value based on the first verification program stored in the third storage medium, and compare the generated hash value with the hash value received from the control ECU 3 to determine an abnormality in the control ECU 3.

Since the hash value generating program 43 is stored in the read-only ROM 22, the hash value generating program 43 cannot be changed. This means that it is impossible or difficult to tamper with the hash value generated based on the hash value generating program 43.

Thus, in the vehicle 1, it is possible to accurately detect tampering with the control ECU RoT 41, that is, an abnormality in the control ECU 3.

The control ECU 3 is configured to generate a hash value based on the first verification program and a predetermined counter value.

This means that the hash value for each startup of the vehicle 1 is different. Therefore, even if a hash value is illegally obtained from outside, the hash value cannot be used for a different startup. The vehicle 1 can thus more securely verify whether the control ECU RoT 41 has been tampered with.

The monitoring ECU 2 is configured to store a hash value for the first verification program in a writable third storage medium, and compare the hash value stored in the third storage medium with the hash value received from the control ECU 3 to determine an abnormality in the control ECU 3.

Even in this case, the vehicle 1 can more securely verify whether the control ECU RoT 41 has been tampered with.

The monitoring ECU 2 is configured to stop the vehicle 1 from starting if detecting an abnormality in the first verification program.

This can prevent the vehicle 1 from behaving abnormally.

1. A vehicle comprising:
a control electronic control unit configured to control an object device mounted on the vehicle; and
a monitoring electronic control unit configured to monitor the control electronic control unit,
wherein the control electronic control unit is configured to store a startup program and a first verification program for verifying whether the startup program has been tampered with in a writable first storage medium, calculate a first hash value for the first verification program, and output the calculated first hash value to the monitoring electronic control unit; and
the monitoring electronic control unit is configured to determine an abnormality in the control electronic control unit based on the first hash value received from the control electronic control unit.

2. The vehicle according to claim 1, wherein the control electronic control unit is configured to store a hash value generating program for generating the first hash value for the first verification program in a read-only second storage
medium, and generate the first hash value for the first verification program based on the hash value generating program; and the monitoring electronic control unit is configured to store the first verification program in a writable third storage medium, generate the second hash value based on the first verification program stored in the third storage medium, and compare the generated second hash value with the first hash value received from the control electronic control unit to determine the abnormality in the control electronic control unit.

3. The vehicle according to claim 2, wherein the control electronic control unit is configured to generate the first hash value based on the first verification program and a predetermined counter value.

4. The vehicle according to claim 1, wherein the monitoring electronic control unit is configured to store the second hash value for the first verification program in a writable third storage medium, and compare the second hash value stored in the third storage medium with the first hash value received from the control electronic control unit to determine the abnormality in the control electronic control unit.

5. The vehicle according to claim 1, wherein the monitoring electronic control unit is configured to stop the vehicle from starting when detecting the abnormality in the first verification program.

6. The vehicle according to claim 2, wherein the monitoring electronic control unit is configured to stop the vehicle from starting when detecting the abnormality in the first verification program.

7. The vehicle according to claim 3, wherein the monitoring electronic control unit is configured to stop the vehicle from starting when detecting the abnormality in the first verification program.

8. The vehicle according to claim 4, wherein the monitoring electronic control unit is configured to stop the vehicle from starting when detecting the abnormality in the first verification program.
